(19) United States
(12) Patent Application Publication
(10) Pub. No.: US 2026/0054210 A1
(43) Pub. Date: Feb. 26, 2026

(54) HEATER ELEMENT AND VEHICLE INTERIOR PURIFICATION SYSTEM

(71) Applicant: NGK INSULATORS, LTD., Nagoya-City (JP)

(72) Inventor: Kaito KAGAMI, Nisshin-Shi (JP)

(73) Assignee: NGK INSULATORS, LTD., Nagoya-City (JP)

(21) Appl. No.: 19/186,836

(22) Filed: Apr. 23, 2025

(30) Foreign Application Priority Data
Aug. 23, 2024 (JP) 2024-143341

(51) Int. Cl. B01D 53/04; B01D 53/86; B01D 53/96; B01J 20/34; B01J 38/02; B60H 1/00; B60H 1/24; B60H 3/06; H05B 3/12

(52) U.S. Cl. CPC B01D 53/0438; B01D 53/86; B01D 53/96; B01J 20/3483; B01J 38/02; B60H 1/00864; B60H 1/248; B60H 3/0608; H05B 3/12; B01D 2255/9155; B01D 2257/504; B01D 2257/708; B01D 2257/80; B01D 2259/40096; B01D 2259/4566; B60H 2003/0691; H05B 2203/016; H05B 2203/02; H05B 2203/024

(57) ABSTRACT

A heater element 1 includes: a honeycomb structure 10 having an outer peripheral wall 100 and partition walls 110, the partition walls 110 defining a plurality of cells 101a, each of the cells 101a extending from a first end face 10a to a second end face 10b of the honeycomb structure 10 to form a flow path, at least the partition walls 101 being made of a material having a positive temperature coefficient (PTC) property; a first electrode 11 and a second electrode 12 provided on the first end face 10a and the second end face 10b, respectively; and a first metal terminal 13 and a second metal terminal 14 provided on the first electrode 11 and the second electrode 12, respectively, wherein at least one of the first metal terminal 13 and the second metal terminal 14 has a plurality of partial electrodes 15.

### FIELD OF THE INVENTION

The present invention relates to a heater element and a vehicle interior purification system.

### BACKGROUND OF THE INVENTION

Patent Literature 1 described below discloses a heater element including: a honeycomb structure having an outer peripheral wall and partition walls provided on an inner side of the outer peripheral wall, the partition walls defining a plurality of cells, each of the cells extending from a first end face to a second end face of the honeycomb structure to form a flow path, at least the partition walls being made of a material having a PTC property; a pair of electrodes provided on the first end face and the second end face; and metal terminals (terminals) provided on at least a part of the pair of electrodes.

By spreading the current from the metal terminals by the electrodes and then allowing it to flow through the honeycomb structure, the current distribution at the end face of the honeycomb structure can be made more uniform, and the temperature distribution of the honeycomb structure can be made more uniform. Patent Literature proposes to use metal terminals integrally provided over the entire circumference of the end faces of the honeycomb structure.

### CITATION LIST

### Patent Literatures

[Patent Literature 1] Japanese Patent Application Publication No. 2024-101454 A

### SUMMARY OF THE INVENTION

When the metal terminals integrally provided over the entire circumference of the end faces of the honeycomb structure are used as in Patent Literature 1, stress may act on the honeycomb structure due to the thermal expansion difference between the metal terminal and the honeycomb structure, causing cracks in the honeycomb structure. The cracks may change the current path and cause non-uniform temperature distribution in the honeycomb structure.

This invention has been made to solve the problems as described above, and one of the objects is to provide a heater element and a vehicle interior purification system that can reduce the stress acting on the honeycomb structure due to the thermal expansion difference between the metal terminal and the honeycomb structure, and reduce the risk of cracks occurring in the honeycomb structure.

As results of intensive studies, the inventors have found that the above problems can be solved by dividing the metal terminal into a plurality of partial electrodes, and have completed the invention.
[1] This invention relates to a heater element comprising: a honeycomb structure having an outer peripheral wall and partition walls provided on an inner side of the outer peripheral wall, the partition walls defining a plurality of cells, each of the cells extending from a first end face to a second end face of the honeycomb structure to form a flow path, at least the partition walls being made of a material having a positive temperature coefficient (PTC) property; a first electrode and a second electrode provided on the first end face and the second end face, respectively; and a first metal terminal and a second metal terminal provided on the first electrode and the second electrode, respectively, wherein at least one of the first metal terminal and the second metal terminal has a plurality of partial electrodes.
[2] The invention may relate to the heater element according to [1], wherein both the first metal terminal and the second metal terminal have a plurality of partial electrodes, respectively.
[3] The invention may relate to the heater element according to [1] or [2], wherein the plurality of partial electrodes are provided over the entire circumference of the honeycomb structure.
[4] The invention may relate to the heater element according to any one of [1] to [3], wherein the plurality of partial electrodes comprise a first partial electrode and a second partial electrode adjacent to each other in a circumferential direction of the honeycomb structure, and wherein end portions of the first partial electrode and the second partial electrode have fitting shapes that fit to each other.
[5] The invention may relate to the heater element according to [4], wherein the end portion of the first partial electrode has a first convex portion provided in contact with an outer edge of the first partial electrode in a width direction of the honeycomb structure, and a first concave portion provided in contact with an extension line of an inner edge of the first partial electrode in the width direction of the honeycomb structure, the first concave portion being provided adjacent to the first convex portion in the width direction of the honeycomb structure, and wherein at least a part of the end portion of the second partial electrode enters the first concave portion in a circumferential direction of the honeycomb structure.
[6] In an embodiment, the invention relates to a vehicle interior purification system, comprising: at least one heater element according to any one of [1] to [5]; a power source for applying a voltage to the heater element; an inflow pipe that communicates a vehicle interior with the first end face of the heater element; an outflow pipe having a first path that communicates the second end face of the heater element with the vehicle interior; and a ventilation fan for allowing air from the vehicle interior to flow into the first end face of the heater element through the inflow pipe.
[7] The invention may relate to the vehicle interior purification system according to [6], wherein the outflow pipe has, in addition to the first path, a second path that communicates the second end face of the heater element with a vehicle exterior, and the outflow pipe has a switching valve configured to switch the flow of the air flowing through the outflow pipe between the first path and the second path, and wherein the vehicle interior purification system comprises a control unit configured to perform switching between a first mode in which an applied voltage from the power source is turned on, the switching valve is switched so that the air flowing through the outflow pipe passes through the first path, and the ventilation fan is turned on; and a second mode in which the applied voltage from the power source is turned on, the switching valve is switched so that the air flowing through the outflow pipe passes through the second path, and the ventilation fan is turned on.

According to one embodiment of the heater element and the vehicle interior purification system, at least one of the first metal terminal and the second metal terminal has a plurality of partial electrodes, so that the stress acting on the honeycomb structure due to the thermal expansion difference between the metal terminal and the honeycomb structure can be alleviated and the risk of cracks occurring in the honeycomb structure can be reduced.

### BRIEF DESCRIPTION OF THE DRAWINGS

FIG. 1 is a front view illustrating a heater element according to an embodiment of the invention;

FIG. 2 is a back view illustrating the heater element in FIG. 1;

FIG. 3 is a right side view illustrating the heater element in FIG. 1;

FIG. 4 is an enlarged view illustrating the region IV in FIG. 1;

FIG. 5 is a front view illustrating a first variation of the heater element in FIG. 1;

FIG. 6 is an enlarged view illustrating the region VI in FIG. 5;

FIG. 7 is a front view illustrating a main part of a second variation of the heater element in FIG. 1;

FIG. 8 is a front view illustrating a main part of a third variation of the heater element in FIG. 1;

FIG. 9 is a front view illustrating a fourth variation of the heater element in FIG. 1;

FIG. 10 is a back view illustrating the heater element in FIG. 9;

FIG. 11 is a right side view illustrating the heater element in FIG. 9;

FIG. 12 is a front view illustrating a main part of a fifth variation of the heater element in FIG. 1;

FIG. 13 is a front view illustrating a main part of a sixth variation of the heater element in FIG. 1;

FIG. 14 is a front view illustrating a main part of a seventh variation of the heater element in FIG. 1;

FIG. 15 is a schematic view of a structure of a vehicle interior purification system according to an embodiment of the invention; and

FIG. 16 is an explanatory view illustrating regions where temperatures were measured in Examples.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### (1. Heater Element)

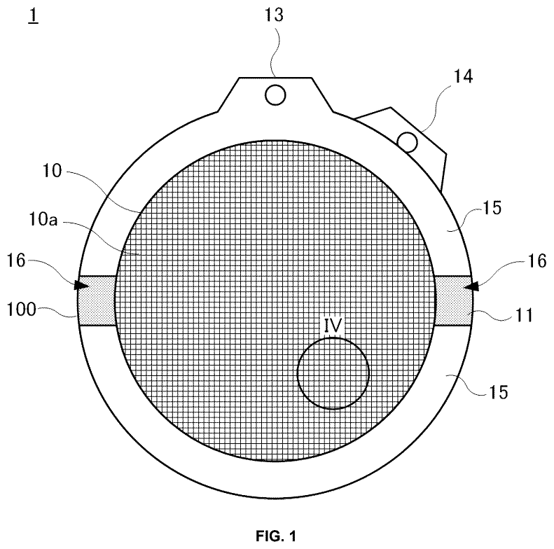

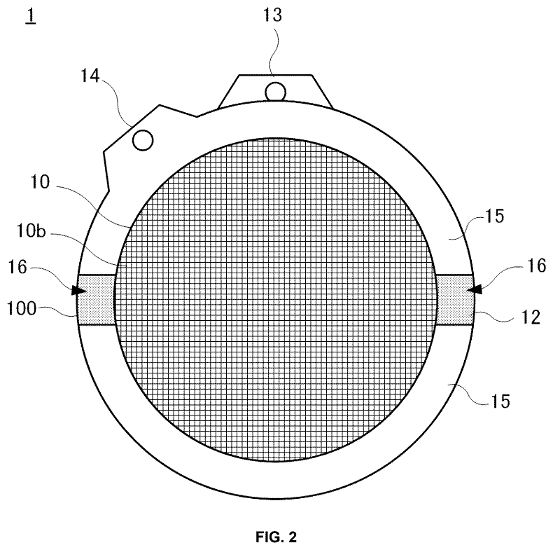

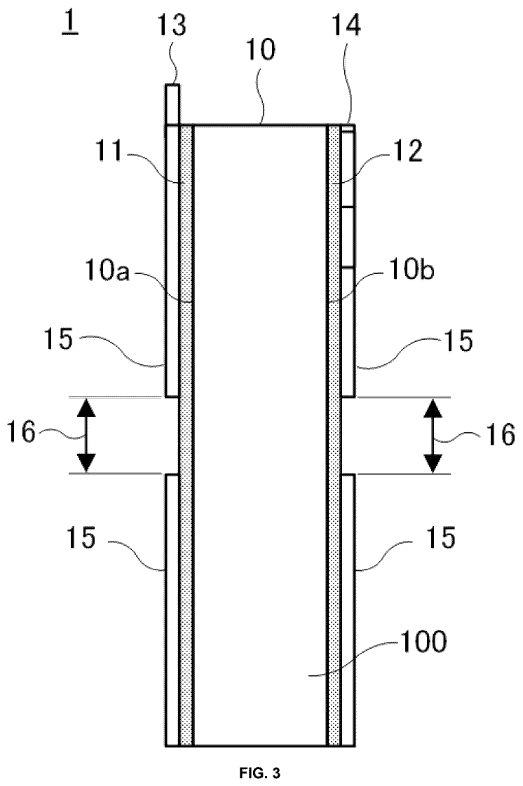

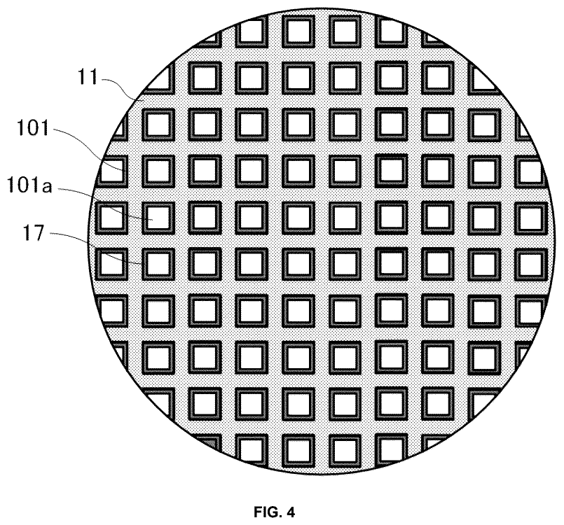

FIG. 1 is a front view illustrating a heater element 1 according to an embodiment of the invention, FIG. 2 is a back view illustrating the heater element 1 in FIG. 1, FIG. 3 is a right side view illustrating the heater element 1 in FIG. 1, and FIG. 4 is an enlarged view illustrating the region IV in FIG. 1.

The heater element 1 according to an embodiment of the invention can be suitably used as a heater element 1 for use in a vehicle interior purification system for various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the heater element 1 according to an embodiment can be suitably used for a vehicle that has no internal combustion engine such as electric vehicles and electric rail cars.

As shown in FIGS. 1 to 4, the heater element 1 includes: a honeycomb structure 10; a first electrode 11; a second electrode 12; a first metal terminal 13; and second metal terminal 14.

The honeycomb structure 10 has an outer peripheral wall 100 and partition walls 101 provided on an inner side of the outer peripheral wall 100, the partition walls 101 defining a plurality of cells 101a, each of the cells 101a extending from a first end face 10a to a second end face 10b of the honeycomb structure 10 to form a flow path. In the honeycomb structure 10, at least the partition walls 101 are made of a material having a PTC (Positive Temperature Coefficient) property. Further, the material having the PTC property has characteristics such that when the temperature increases to exceed the Curie point, the resistance value is sharply increased, making it difficult for electricity to flow.

As particularly illustrated in FIG. 3, the first electrode 11 is provided on the first end face 10a of the honeycomb structure 10, and the second electrode 12 is provided on the second end face 10b of the honeycomb structure 10. The first electrode 11 and the second electrode 12 are provided on the end face of the outer peripheral wall 100 as illustrated in FIGS. 1 and 2, and provided on the end face of the partition walls 101 as illustrated in FIG. 4. On the first electrode 11 and on the second electrode 12, the cells 101a are not plugged. However, a part of cells 101a may be plugged on the first electrode 11 and/or by the second electrode 12.

As illustrated in FIGS. 1 to 3, the first metal terminal 13 is provided on the first electrode 11, and the second metal terminal 14 is provided on the second electrode 12.

A positive electrode of a power source (not shown) is connected to one of the first metal terminal 13 and the second metal terminal 14, and a negative electrode of the power source is connected to the other of the first metal terminal 13 and the second metal terminal 14. Assuming that the positive electrode is connected to the first metal terminal 13 and the negative electrode is connected to the second metal terminal 14, the current from the first metal terminal 13 spreads over the first end face 10a through the first electrode 11, flows through the honeycomb structure 10 in the extending direction of the cells 101a, and flows on the second end face 10b through the second terminal 12 into the second metal terminal 14. The current flows in such a manner, thereby heating the honeycomb structure 10 uniformly.

In the heater element 1 according to this embodiment, at least one of the first metal terminal 13 and the second metal terminal 14 has a plurality of partial electrodes 15. In other words, at least one of the first metal terminal 13 and the second metal terminal 14 is not integrally provided over the entire circumference of the end face of the honeycomb structure 10, but it is divided into multiple partial electrodes 15 (pieces) in the circumferential direction of the honeycomb structure 10.

If the first metal terminal 13 and the second metal terminal 14 are integrally provided over the entire circumference of the end face of the honeycomb structure 10, stress may act on the honeycomb structure 10 due to the thermal expansion difference between the first metal terminal 13 and the second metal terminal 14 and the honeycomb structure 10, causing cracks in the honeycomb structure 10. The cracks may block the flow of current, resulting in uneven temperature distribution in the honeycomb structure 10. However, when as in this embodiment, at least one of the first metal terminal 13 and the second metal terminal 14 has a plurality of partial electrodes 15, the stress that will act on the honeycomb structure 10 due to the thermal expansion difference between the first metal terminal 13 and the second metal terminal 14 and the honeycomb structure 10 can be alleviated, so that the risk of cracks in the honeycomb structure 10 can be reduced. This can reduce the risk of the current flow being interrupted by cracks and reduce the risk of non-uniform temperature distribution in the honeycomb structure 10.

As illustrated in FIGS. 1 and 2, in the heater element 1 according to this embodiment, both of the first metal terminal 13 and the second metal terminal 14 have a plurality of partial electrodes 15, respectively. This can more reliably reduce the risk of cracking in the honeycomb structure 10. However, only one of the first metal terminal 13 and the second metal terminal 14 may have a plurality of partial electrodes 15, and the other may be provided integrally over the entire circumference of the end face of the honeycomb structure 10.

As illustrated in FIGS. 1 and 2, in the heater element 1 according to this embodiment, the partial electrodes 15 are provided around the entire circumference of the honeycomb structure 10. For example, when a ratio (L1/L0) of the total length (L1) of the outer edges of the partial electrodes 15 to the total peripheral length (L0) of the honeycomb structure 10 at the outer edge(s) of the first end face 10a and/or the second end face 10b is 80% or more, it is understandable that the plurality of partial electrodes 15 are provided over the entire circumference of the honeycomb structure 10. The outer edge means the outer edge in the width direction of the honeycomb structure 10. When the honeycomb structure 10 is circular as illustrated, the width direction means the radial direction. By providing the plurality of partial electrodes 15 over the entire circumference of the honeycomb structure 10, the current is spread more evenly across the first end face 10a and the second end face 10b of the honeycomb structure 10.

In the embodiments illustrated in FIGS. 1 to 4, separating regions 16 extending linearly in the width direction of the honeycomb structure 10 are provided between the end portions of the plurality of partial electrodes 15. The end portions of the plurality of partial electrodes 15 are separated in the circumferential direction of the honeycomb structure 10 without fitting into each other.

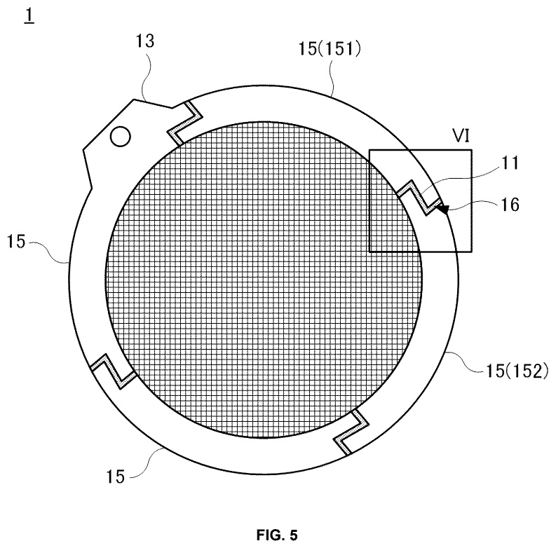

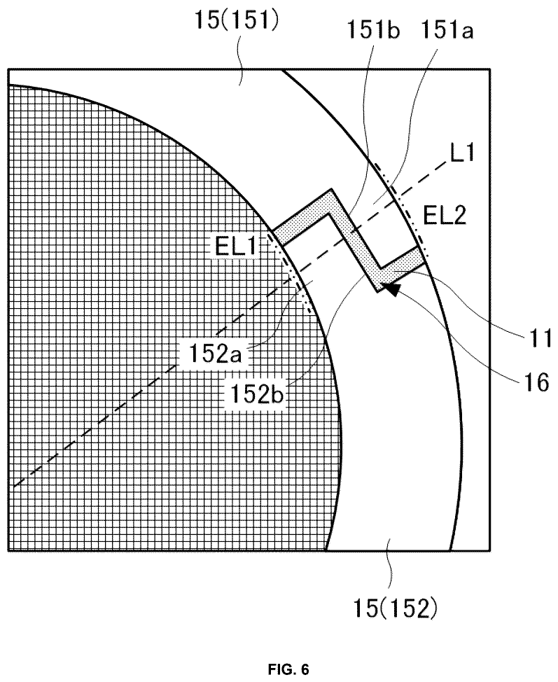

Next, FIG. 5 is a front view of the first variation of the heater element 1 in FIG. 1, and FIG. 6 is an enlarged view of the region VI in FIG. 5. As illustrated in FIGS. 5 and 6, the plurality of partial electrodes 15 includes a first partial electrode 151 and a second partial electrode 152 adjacent to each other in the circumferential direction of the honeycomb structure 10. The end portions of the first partial electrode 151 and the second partial electrode 152 have fitting shapes that fit to each other. The term “fitting shape” means shapes that fit to each other. In other words, the end portions of the first partial electrode 151 and the second partial electrode 152 are provided to lap each other in the circumferential direction of the honeycomb structure 10.

In addition, FIGS. 5 and 6 illustrate that the end portions of the first partial electrode 151 and the second partial electrode 152 of the first metal terminal 13 provided on the front side of the heater element 1 have fitting shapes that fit to each other. However, the second metal terminal 14 located on the back surface of the heater element 1 may be similarly configured. The terms “first partial electrode 151 and second partial electrode 152” represent any two partial electrodes 15 adjacent to each other in the circumferential direction of the honeycomb structure 10, of the plurality of partial electrodes 15, and are not intended to limit the number of the partial electrodes 15.

As described above, the heater element 1 in this embodiment reduces the risk of cracking in the honeycomb structure 10. However, in the embodiment such as that illustrated in FIGS. 1 to 4 in which the end portions of the plurality of partial electrodes 15 have shapes that do not fit to each other, if cracking were to occur across the linear separating region 16, a part of the honeycomb structure 10 would be electrically isolated, and the current to that part of the honeycomb structure 10 may be interrupted.

On the other hand, in the embodiment where the end portions of the first partial electrode 151 and the second partial electrode 152 have the fitting shapes that fit to each other, as in the first variation, the shape of the separating region 16 can be made complex. Even if the cracking occurs along the line L1 illustrated in FIG. 6, the cracks cross not only the separating region 16 but also the end portions of the first partial electrode 151 and/or the second partial electrode 152. The end portions of the first partial electrode 151 and/or the second partial electrode 152 are not interrupted by the cracks, and for example, the current flowing through the first partial electrode 151 can flow into the first electrode 11 at a position beyond the crack. Therefore, in the embodiment in which the end portions of the first partial electrode 151 and the second partial electrode 152 have fitting shapes that fit in each other, as in the first variation, the risk that a part of the honeycomb structure 10 is electrically isolated can be reduced, and the risk that the current to a part of the honeycomb structure 10 is blocked can be reduced.

In the first variation illustrated in FIGS. 5 and 6, the end portion of the first partial electrode 151 has a first convex portion 151a provided in contact with the outer edge of the first partial electrode 151 in the width direction of the honeycomb structure 10, and a first concave portion 151b provided in contact with an extension line EL1 of the inner edge of the first partial electrode 151 in the width direction of the honeycomb structure 10, the first concave portion 151b being located adjacent to the first convex portion 151a in the width direction of the honeycomb structure 10. In the circumferential direction of the honeycomb structure 10, at least a part of the end portion of the second partial electrode 152 enters the first convex portion 151b.

In the first variation illustrated in FIGS. 5 and 6, the end portion of the second partial electrode 152 has a second convex portion 152a provided in contact with the inner edge of the second partial electrode 152 in the width direction of the honeycomb structure 10, and a second concave portion 152b provided in contact with an extension line EL2 of the outer edge of the second partial electrode 152 in the width direction of the honeycomb structure 10, the second concave portion 152b being located adjacent to the second convex portion 152a in the width direction. In the circumferential direction of the honeycomb structure 10, the first convex portion 151a enters the second concave portion 152b, and the second convex portion 152a enters the first concave portion 151b.

The fitting shape as illustrated in FIGS. 5 and 6 may be referred to as a “Z-shaped” fitting shape.

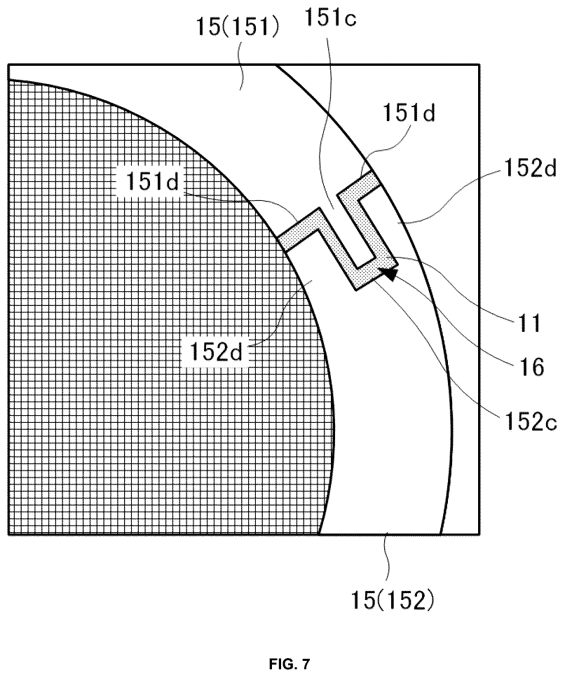

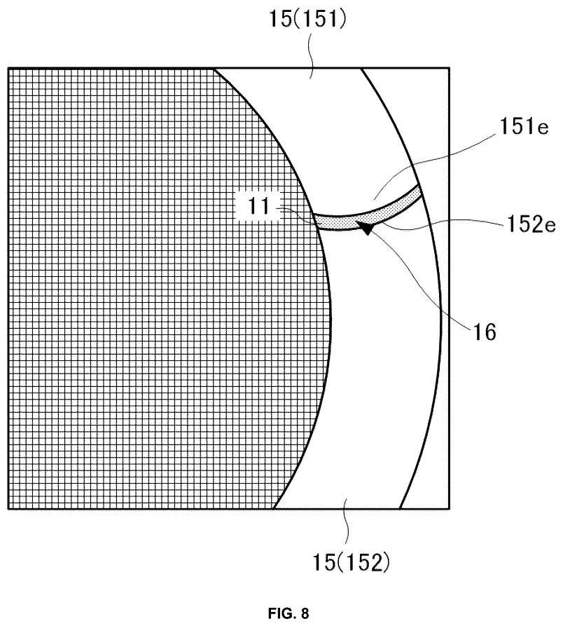

Next, FIG. 7 is a front view illustrating a main portion of a second variation of the heater element 1 in FIG. 1, and FIG. 8 is a front view illustrating a main portion of a third variation of the heater element 1 in FIG. 1. The fitting shape of the end portions of the first partial electrode 151 and the second partial electrode 152 is not limited to the “Z-shaped” fitting shape as illustrated in FIGS. 5 and 6, and it may be another shape.

For example, the fitting shape may be “U-shaped” as in the second variation illustrated in FIG. 7. In the second variation, the end portion of the first partial electrode 151 has a third convex portion 151c provided at a middle position of the first partial electrode 151 in the width direction of the honeycomb structure 10, and third concave portions 151d provided on both sides of the third convex portion 151c in the width direction of the honeycomb structure 10. The end portion of the second partial electrode 152 has a fourth concave portion 152c provided at the middle position of the second partial electrode 152 in the width direction of the honeycomb structure 10, and fourth convex portions 152d provided on both sides of the fourth concave portion 152c in the width direction of the honeycomb structure 10. In the circumferential direction of the honeycomb structure 10, the third convex portion 151c enters the fourth concave portion 152c and the fourth convex portion 152d enters the third concave portion 151d.

The fitting shape may be “circular” as in the third variation as illustrated in FIG. 8. In the third variation, the end portion of the first partial electrode 151 has a circular fifth convex portion 151e and the end portion of the second partial electrode 152 has a circular fifth concave portion 152e. In the circumferential direction of the honeycomb structure 10, the fifth convex portion 151e enters the fifth concave portion 152e.

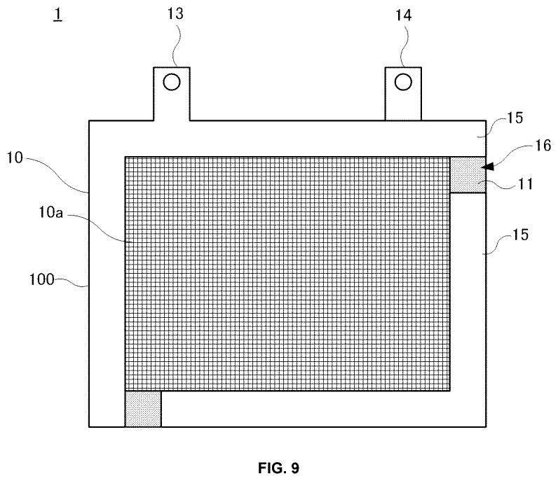

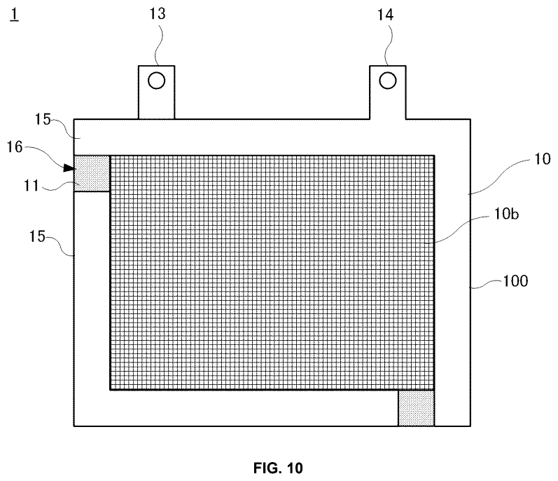

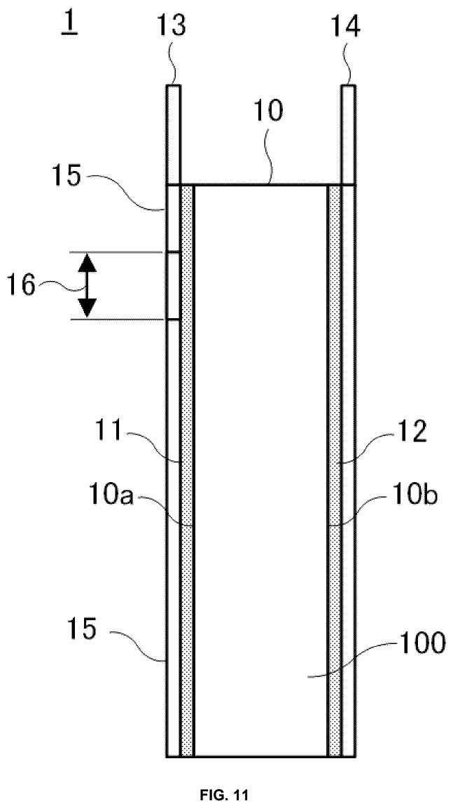

Next, FIG. 9 illustrates a front view of a fourth variation of the heater element 1 in FIG. 1, FIG. 10 illustrates a back view of the heater element 1 in FIG. 9, and FIG. 11 illustrates a right side view of the heater element 1 in FIG. 9. Although in FIGS. 1 to 8, the heater element 1 is illustrated so that the outer shape is circular, the outer shape of the heater element 1 may be changed as desired. For example, the outer shape of the heater element 1 may be quadrangular, as in the fourth variation as illustrated in FIGS. 9 to 11. In the fourth variation, the end portions of the plurality of partial electrodes 15 are separated in the circumferential direction of the honeycomb structure 10 without fitting into each other.

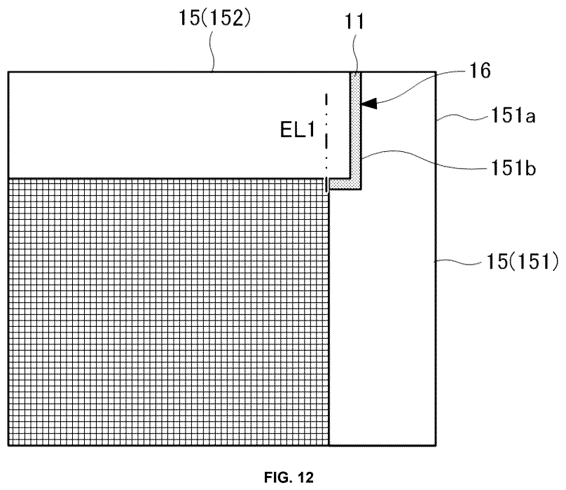

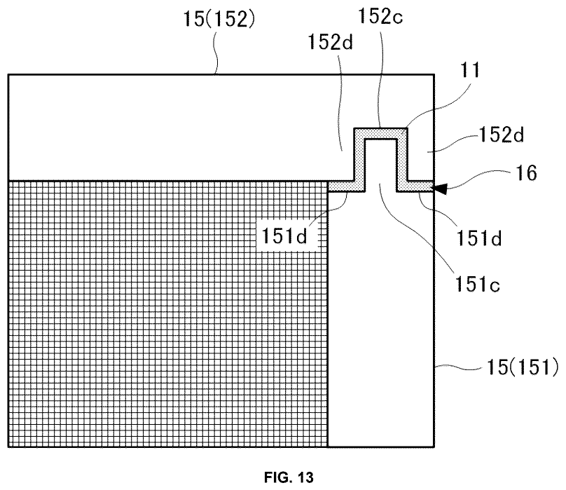

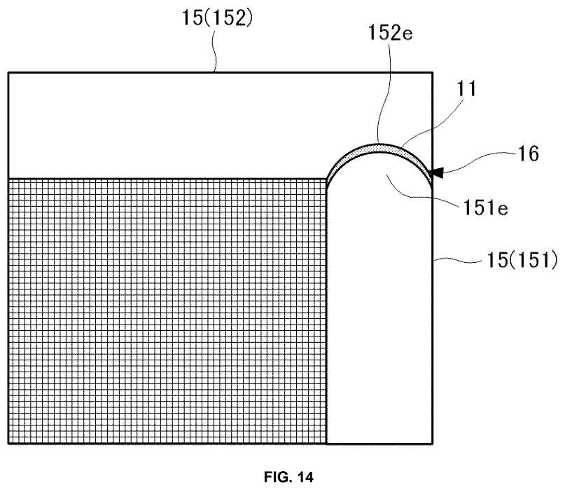

Next, FIG. 12 is a front view illustrating a main part of a fifth variation of the heater element 1 in FIG. 1, FIG. 13 is a front view illustrating a main part of a sixth variation of the heater element 1 in FIG. 1, and FIG. 14 is a front view illustrating a main part of a seventh variation of the heater element 1 in FIG. 1. Even when the outer shape of the heater element 1 is quadrangular, the end portions of the first partial electrode 151 and the second partial electrode 152 may have fitting shapes that fit to each other. The fitting shape may be “Z-shaped” as in the fifth variation as illustrate in FIG. 12, “U-shaped” as in the sixth variation a illustrated in FIG. 13, or “circular” as in the seventh variation as illustrated in FIG. 14. These fitting shapes correspond to those described with reference to FIGS. 5 to 8, respectively. However, FIG. 12 illustrates the fitting shape in which the end portion of the second partial electrode 152 does not have the second convex portion 152a and the second concave portion 152b, and the entire end portion of the second partial electrode 152 enters the first concave portion 151b. Such a fitting shape is also included in the “Z-shaped”. FIG. 13 also illustrates the fitting shape in which one fourth convex portion 152d is provided integrally with the other portions of the second partial electrode 152. Such a fitting shape is also included in the “U-shaped”.

Each of the components of the heater element 1 will now be described in detail.

### (1-1. Honeycomb Structure)

The shape of the honeycomb structure 10 is not particularly limited. For example, an outer shape of a cross section of the honeycomb structure 10 orthogonal to the flow path direction (extending direction of the cells 101a) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 10a and second end face 10b) have the same shape as the cross section. Also, when the cross section and the end faces are polygonal, the corners may be chamfered.

The shape of each cell 101 a is not particularly limited, but it may be polygonal such as quadrangular, pentagonal, hexagonal, heptagonal, and octagonal, circular, or oval in the cross section of the honeycomb structure 10 orthogonal to the flow path direction. These shapes may be alone or in combination of two or more. Moreover, among these shapes, the quadrangle or the hexagon is preferable. By providing the cells 101 a having such a shape, it is possible to reduce the pressure loss when the air flows. In FIGS. 1 to 14, the honeycomb structure 10 is illustrated as an example in which the outer shape of the cross section and the shape of each cell 101a are quadrangular in the cross section orthogonal to the flow path direction.

The honeycomb structure 10 may be a honeycomb joined body that includes a plurality of honeycomb segments and joining layers that join outer peripheral side surfaces of the plurality of honeycomb segments together. The use of the honeycomb joined body can increase the total cross-sectional area of the cells 101a, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 100 and the partition walls 101. In addition to the role of joining the honeycomb segments to each other, the joining material can also be used as an outer peripheral coating material after joining the honeycomb segments.

From the viewpoints of ensuring the strength of the honeycomb structure 10, reducing pressure loss when air passes through the cells 101a, ensuring the amount of functional material supported, and ensuring the contact area with the air flowing inside the cells 101a, it is desirable to suitably combine a thickness of the partition wall 101, a cell density, and a cell pitch (or an opening ratio of the cells).

As used herein, the cell density refers to a value obtained by dividing a number of cells by an area of one end face (first end face 10a or second end face 10b) of the honeycomb structure 10 (the total area of the partition walls 101 and the cells 101a excluding the outer peripheral wall 100).

As used herein, the cell pitch refers to a value obtained by the following calculation. First, the area of one end face (first end face 10a or second end face 10b) of the honeycomb structure 10 (the total area of the partition walls 101 and the cells 101a excluding the outer peripheral wall 100) is divided by the number of the cells to calculate an area per a cell. A square root of the area per a cell is then calculated, and this is determined to be the cell pitch.

As used herein, the opening ratio of the cells 101a refers a value obtained by dividing the total area of the cells 101a defined by the partition walls 101 by the area of one end face (first end face 10a or second end face 10b) (the total area of the partition walls 101 and the cells 101a excluding the outer peripheral wall 100) in the cross section orthogonal to the flow path direction of the honeycomb structure 10. In addition, when calculating the opening ratio of the cells 101a, the first electrode 11, the second electrode 12, and a functional material-containing layer 17 as described below are not taken into consideration.

In an embodiment that is advantageous from the viewpoint of supporting a sufficient amount of functional material, the thickness of the partition walls 101 is 0.300 mm or less, the cell density is 100 cells/cm² or less, and the cell pitch is 1.0 mm or more. In a preferred embodiment, the thickness of the partition walls 101 is 0.200 mm or less, the cell density is 70 cells/cm² or less, and the cell pitch is 1.2 mm or more. In a more preferred embodiment, the thickness of the partition walls is 0.130 mm or less, the cell density is 65 cells/cm² or less, and the cell pitch is 1.3 mm or more.

In each embodiment as described above, from the viewpoints of ensuring the strength of the honeycomb structure 10 and maintaining lower electrical resistance, the lower limit of the thickness of the partition walls 101 is preferably 0.010 mm or more, more preferably 0.020 mm or more, and even more preferably 0.030 mm or more.

In each embodiment as described above, from the viewpoints of ensuring the strength of the honeycomb structure 10, maintaining lower electrical resistance, and increasing a surface area to facilitate reaction, adsorption, and separation, the lower limit of the cell density is 30 cells/cm² or more, and preferably 35 cells/cm² or more, and even more preferably 40 cells/cm² or more.

In each embodiment as described above, from the viewpoints of ensuring the strength of the honeycomb structure 10, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition walls 101 is 0.08 to 0.36 mm, the cell density is 2.54 to 140 cells/cm², and the opening ratio of the cells 101a is 0.70 or more. In a preferred embodiment, the thickness of the partition walls 101 is 0.09 to 0.35 mm, the cell density is 15 to 100 cells/cm², and the opening ratio of the cells 101a is 0.80 or more. In a more preferred embodiment, the thickness of the partition walls 101 is 0.14 to 0.30 mm, the cell density is 20 to 90 cells/cm², and the opening ratio of the cells 101a is 0.85 or more.

In each embodiment as described above, from the viewpoint of ensuring the strength of the honeycomb structure 10, the upper limit of the opening ratio of the cells 101a is preferably 0.94 or less, more preferably 0.92 or less, and even more preferably 0.90 or less.

Although the thickness of the outer peripheral wall 100 is not particularly limited, it is preferably determined based on the following considerations. First, from the viewpoint of reinforcing the honeycomb structure 10, the thickness of the outer peripheral wall 100 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 100 is preferably 1.0 mm or less, more preferably 0.5 mm, even more preferably 0.4 mm or less, and still more preferably 0.3 mm or less.

As used herein, the thickness of the outer peripheral wall 100 refers to a length from a boundary between the outer peripheral wall 100 and the outermost cell 101 a or the partition wall 101 to a side surface of the honeycomb structure 10 in a normal line direction of the side surface in the cross section orthogonal to the flow path direction.

The length of the honeycomb structure 10 in the flow path direction and the cross-sectional area of the honeycomb structure 10 orthogonal to the flow path direction may be adjusted according to the required size of the heater element 1, and are not particularly limited. For example, when used in a compact heater element 1 while ensuring a predetermined function, the honeycomb structure 10 can have a length of 2 to 20 mm in the flow path direction and have a cross-sectional area of 10 cm² or more orthogonal to the flow path direction. Although the upper limit of the cross-sectional area orthogonal to the flow path direction is not particularly limited, it is, for example, 300 cm².

The partition walls 101 forming the honeycomb structure 10 are made of a material that can be heated by electric conduction, specifically made of a material having the PTC property. Further, the outer peripheral wall 100 may also be made of a material having a PTC property, as with the partition walls 101, as needed. By such a configuration, the functional material-containing layer 17 can be heated by heat transfer from the heat-generating partition walls 101 (and optionally the outer peripheral wall 100). Further, the material having the PTC property has characteristics such that when the temperature increases to exceed the Curie point, the resistance value is sharply increased, making it difficult for electricity to flow. Therefore, when the temperature of the heater element 1 becomes high, the current flowing through the partition walls 101 (and the outer peripheral wall 100 if necessary) is limited, thereby suppressing excessive heat generation of the heater element 1. Therefore, it is possible to suppress thermal deterioration of the functional material-containing layer 17 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271:2008.

From the viewpoints of creating a device that can be heated by electric conduction and have the PTC property, the outer peripheral wall 100 and the partition walls 101 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer peripheral wall 100 and the partition walls 101 are substantially free of lead (Pb). Specifically, the outer peripheral wall 100 and the partition walls 101 preferably have a Pb content of 0.01% by mass or less, and more preferably 0.001% by mass or less, and still more preferably 0% by mass. The lower Pb content can allow the air heated by contact with the heat-generating partition walls 101 to be safely applied to organisms such as humans, for example. In the outer peripheral wall 100 and the partition walls 101, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In terms of efficiently heating the air, the material making up the outer peripheral wall 100 and the partition walls 101 preferably have a lower limit of a Curie point of 80° C. or more, more preferably 100° C. or more, and even more preferably 125° C. or more. Further, in terms of safety as a component placed in the vehicle interior or near the vehicle interior, the upper limit of the Curie point is preferably 250° C. or more, more preferably 225° C. or more, even more preferably 200° C. or more, and still more preferably 150° C. or more.

The Curie point of the material making up the outer peripheral wall 100 and the partition walls 101 can be adjusted by the type and amount of shifter added. For example, the Curie point of barium titanate (BaTiO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (1-2. First Electrode and Second Electrode)

The first electrode 11 and the second electrode 12 are provided on the first end face 10a and the second end face 10b, respectively. Applying a voltage between the first electrode 11 and the second electrode 12 allows the honeycomb structure 10 to generate heat by Joule heat.

The first electrode 11 and the second electrode 12 may employ, for example, a metal or alloy containing at least one selected from Cu, Ag, Al, Ni and Si, although not particularly limited thereto. It is also possible to use an ohmic electrode capable of ohmic contact with the outer peripheral wall 100 and/or the partition walls 101 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 11 and the second electrode 12 may have a single-layer structure, or may have a laminated structure of two or more layers. When the first electrode 11 and the second electrode 12 have the laminated structure of two or more layers, the materials of the respective layers may be of the same type or of different types.

The thicknesses of the first electrode 11 and the second electrode 12 may be appropriately set according to the method for forming the first electrode 11 and the second electrode 12. The method for forming the first electrode 11 and the second electrode 12 includes metal deposition methods such as sputtering, vapor deposition, electrolytic deposition, and chemical deposition. Alternatively, the first electrode 11 and the second electrode 12 can be formed by applying an electrode paste and then baking it, or by thermal spraying. Furthermore, the first electrode 11 and the second electrode 12 may be formed by joining metal sheets or alloy sheets.

Each thickness of the first electrode 11 and the second electrode 12 is, for example, about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (1-3. First Metal Terminal and Second Metal Terminal)

The provision of the first metal terminal 13 and the second metal terminal 14 facilitates connection to an external power source. The first metal terminal 13 and the second metal terminal 14 are connected to a conductor connected to the external power source.

The metal that makes up the first metal terminal 13 and the second metal terminal 14 may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze. Furthermore, the thickness of each of the first metal terminal 13 and the second metal terminal 14 is not particularly limited, but it is, for example, 0.01 to 10 mm, typically 0.05 to 5 mm.

The method of connecting the first metal terminal 13 and the second metal terminal 14 to the first electrode 11 and the second electrode 12, respectively, is not particularly limited as long as they are electrically connected. For example, they can be connected by diffusion bonding, a mechanical pressing mechanism, welding, or the like.

### (1-4. Intermediate Material)

Intermediate materials may be provided between: the first electrode 11 and the second electrode 12; and the first metal terminal 13 and the second metal terminal 14. The provision of the intermediate materials results in high structural freedom of the connection between the first electrode 11 and the second electrode 12 and the first metal terminal 13 and the second metal terminal 14. The intermediate material may be made of non-limiting materials, and it may be the same as the material of the first metal terminal 13 and the second metal terminal 14 as described above. Moreover, the material of the intermediate material may be different from that of the first metal terminal 13 and the second metal terminal 14 as described above. In this case, the intermediate material can be made of a solder, a brazing material, a conductive adhesive, or the like. The method of connecting the intermediate materials to the first metal terminal 13 and the second metal terminal 14 and the first electrode 11 and the second electrode 12 is not particularly limited as long as they are electrically connected. For example, they can be connected by diffusion bonding, a mechanical pressing mechanism, welding, or the like.

### (1-5. Functional Material-Containing Layer)

As illustrated in FIG. 4, the heater element 1 may be provided with a functional material-containing layer 17 on each surface of the partition walls 101. The functional material-containing layer 17 can be provided on each surface of the partition walls 101 (in the case of the outermost cells 101a, the partition walls 101 that define the outermost cells 101a and the outer peripheral wall 100). By thus providing the functional material-containing layer 17, the functional material contained in the functional material-containing layer 17 can be easily heated, so that the desired function due to the functional material-containing layer 17 can be exerted.

The functional material contained in the functional material-containing layer 17 is not particularly limited as long as it can exhibit the desired function, but an adsorbent and the like can be used. The adsorbent preferably has a function of adsorbing removing components in the air, for example, at least one selected from water vapor, carbon dioxide and volatile components. Also, the use of the catalyst allows the removing components to be purified. Furthermore, the adsorbent and the catalyst may be used together for the purpose of enhancing the function of the absorbent to capture the removing components.

The adsorbent preferably has a function that can adsorb the removing components, for example, water vapor, carbon dioxide and volatile components, etc., at −20 to 40° C. and release them at an elevated temperature of 60° C. or more. Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the components to be removed. The adsorbent may be used alone, or in combination with two or more types.

The catalyst preferably has a function capable of promoting the oxidation-reduction reaction. The catalyst having such a function includes metal catalysts such as Pt, Pd and Ag, and oxide catalysts such as CeO₂ and ZrO₂. The catalyst may be used alone or in combination of two or more types.

The volatile components contained in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the functional material-containing layer 17 may be determined according to the size of the cells 101a, and is not particularly limited. For example, from the viewpoint of ensuring sufficient contact with air, the thickness of the functional material-containing layer 17 is preferably 20 μm or more, more preferably 25 μm or more, and even more preferably 30 μm or more. On the other hand, from the viewpoint of suppressing separation of the functional material-containing layer 17 from the partition walls 101 and the outer peripheral wall 100, the thickness of the functional material-containing layer 17 is preferably 400 μm or less, more preferably 380 μm or less, and even more preferably 350 μm or less.

The thickness of the functional material-containing layer 17 is measured using the following procedure. Any cross section of the honeycomb structure 10 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 10. The thickness of each functional material-containing layer 17 visually recognized from the cross-sectional image is calculated by dividing the cross-sectional area by the length of the cells 101 a in the flow path direction. This calculation is performed for all the functional material-containing layers 17 visually recognized from the cross-sectional image, and an average value thereof is determined to be the thickness of the functional material-containing layer 17.

From the viewpoint of the functional material exerting a desired function in the heater element 1, an amount of the functional material-containing layer 17 is preferably 50 to 500 g/L, more preferably 100 to 400 g/L, and even more preferably 150 to 350 g/L, based on the volume of the honeycomb structure 10. It should be noted that the volume of the honeycomb structure 10 is a value determined by the external dimensions of the honeycomb structure 10.

### (2. Method for Producing Heater Element)

The method for producing the heater element according to an embodiment of the invention is not particularly limited as long as it is a method having the characteristics as described above, and can be carried out in accordance with a known method. Hereinafter, the method for producing the heater element according to an embodiment of the invention will be specifically described.

A method for producing the honeycomb structure forming the heater element includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 10 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 10 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 10.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 10 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost

A firing furnace used in the firing step and the degreasing step is not particularly limited, but it may be an electric furnace, a gas furnace, or the like.

The first electrode 11 and the second electrode 12 are formed on the honeycomb structure 10 thus obtained, whereby the heater element 1 can be produced. The first electrode 11 and the second electrode 12 can also be formed by metal deposition methods such as sputtering, vapor deposition, electrolytic deposition, and chemical deposition. Further, the first electrode 11 and the second electrode 12 can also be formed by applying an electrode paste and then baking it. Furthermore, the first electrode 11 and the second electrode 12 can also be formed by thermal spraying. The first electrode 11 and the second electrode 12 may be composed of a single layer, but may also be composed of a plurality of electrode layers having different compositions. A typical method for forming the first electrode 11 and the second electrode 12 will be described below.

First, an electrode slurry containing an electrode material, an organic binder, and a dispersion medium is prepared, and the first end face 10a or the second end face 10 b of the honeycomb structure 10 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 10 is removed by blowing and wiping. The slurry can be then dried to form the first electrode 11 and the second electrode 12 on the first end face 10a or the second end face 10 b of the honeycomb structure 10. The drying can be performed while heating the heater element 1 to a temperature of about 120 to 600° C., for example. Although a series of steps of coating, slurry removal, and drying may be performed only once, the steps can be repeated multiple times to provide the first electrode 11 and the second electrode 12 having desired thicknesses.

The first metal terminal 13 and the second metal terminal 14 are then placed at predetermined positions of the first electrode 11 and the second electrode 12, respectively, and the first electrode 11 and the second electrode 12 are connected to the first metal terminal 13 and the second metal terminal 14, respectively. As a method of connecting the first electrode 11 and the second electrode 12 to the terminals, the method described above can be used. Further, when the intermediate materials are provided between: the first electrode 11 and the second electrode 12; and the first metal terminal 13 and the second metal terminal 14, the intermediate material can be placed at a predetermined position of the first electrode 11 and the second electrode 12 and connected to each other, and then the first metal terminal 13 and the second metal terminal 14 can be placed at a predetermined position of the intermediate material and connected to each other. As a method for connecting these, the method as described above can be used.

It should be noted that the first metal terminal 13, the second metal terminal 14 and the intermediate material may be provided after the functional material-containing layer 17 described below is formed.

The functional material-containing layer 17 is then formed on each surface of the partition walls 101 and the like of the heater element 1 thus obtained, thereby obtaining a heater element with functional material-containing layers.

Although the method for forming the functional material-containing layer 17 is not particularly limited, it can be formed, for example, by the following steps. The heater element 1 is immersed in a slurry containing a functional material, an organic binder, and a dispersion medium for a predetermined period of time, and an excess slurry on the end faces and the outer periphery of the honeycomb structure 10 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the functional material-containing layer 17 on each surface of the partition walls 101. The drying can be performed while heating the heater element 1 to a temperature of about 120 to 600° C., for example. Although a series of steps of immersion, slurry removal, and drying may be performed only once, the steps can be repeated multiple times to provide the functional material-containing layer 17 having the desired thickness on the surfaces of the partition walls 101 and the like.

### (3. Vehicle Interior Purification System)

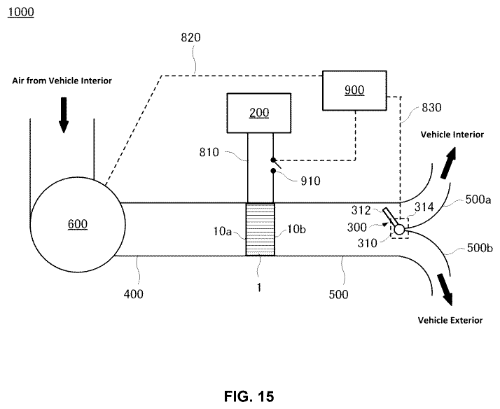

FIG. 15 is a schematic view of a structure of a vehicle interior purification system 1000 according to an embodiment of the invention. According to an embodiment of the invention, there is provided a vehicle interior purification system 1000 including the heater element 1 described above. The vehicle interior purification system 1000 can be suitably utilized for various vehicles such as automobiles.

As illustrated in FIG. 15, the vehicle interior purification system 1000 includes: at least one heater element 1; a power source 200 such as a battery for applying a voltage to the heater element 1; an inflow pipe 400 that communicates a vehicle interior with a first end face 10a of the heater element 1; an outflow pipe 500 having a first path 500a that communicates a second end face 10b of the heater element 1 with the vehicle interior; and a ventilation fan 600 for allowing the air from the vehicle interior to flow into the first end face 10a of the heater element 1 via the inflow pipe 400.

In addition to the first path 500a, the outflow pipe 500 can have a second path 500b that communicates the second end face 10b of the heater element 1 to a vehicle exterior. The outflow pipe 500 may also have a switching valve 300 configured to switch the flow of the air passing through the outflow pipe 500 between the first path 500a and the second path 500b.

The vehicle interior purification system 1000 can have operating modes of: a first mode in which an applied voltage from the power source 200 is turned off, the switching valve 300 is switched so that the air flowing through the outflow pipe 500 passes through the first path 500a, and the ventilation fan 600 is turned on; and a second mode in which the applied voltage from the power source 200 is turned on, the switching valve 300 is switched so that the air flowing through the outflow pipe 500 passes through the second path 500b, and the ventilation fan 600 is turned on.

The vehicle interior purification system 1000 may include a control unit 900 configured to perform switching between the first mode and the second mode. The control unit 900 may be configured, for example, to be able to alternately perform the first mode and the second mode. By repeating the switching between the first mode and the second mode at a fixed cycle, the removing components in the vehicle interior can be stably discharged to the vehicle exterior.

In the first mode, the air in the vehicle interior is purified. Specifically, the air from the vehicle interior flows in the first end face 10a of the heater element 1 through the inflow pipe 400, passes through the heater element 1, and then flows out from the second end face 10b of the heater element 1. The removing components in the air from the vehicle interior are removed such as by being captured with the functional material while passing through the heater element 1. Clean air flowing out of the second end face 10b of the heater element 1 is returned to the vehicle interior through the first path 500a of the outflow pipe 500.

In the second mode, the functional material is regenerated. Specifically, the air from the vehicle interior flows in the first end face 10a of the heater element 1 through the inflow pipe 400, passes through the heater element 1, and then flows out from the second end face 10b of the heater element 1. The heater element 1 generates heat due to electrical conduction, which heats the functional material supported on the heater element 1, so that the removing components that are captured in the functional material are separated from the functional material or react with it.

In order to promote the separation of the removing components that have been captured or the like in the functional material, it is preferable to heat the functional material to a temperature equal to or higher than the separation temperature depending on the type of functional material. For example, when the adsorbent is used as the functional material, it is preferable to heat at least a part of the functional material, preferably the whole functional material, to 70 to 150° C., more preferably to 80 to 140° C., and even more preferably to 90 to 130° C. The second mode is preferably performed for a period of time until the functional material is fully regenerated. Depending on the type of functional material, for example, if the adsorbent is used as the functional material, in the second mode, the functional material is preferably heated in the above temperature range for 1 to 10 minutes, more preferably for 2 to 8 minutes, and even more preferably 3 to 6 minutes.

The air from the vehicle interior flows out from the second end face 10b of the heater element 1 together with the removing components that have been separated from the functional material while passing through the heater element 1. The air containing the removing components that has flowed out from the second end face 10b of the heater element 1 is discharged to the vehicle interior through the second path 500b of the outflow pipe 500.

The turning-on and turning-off of the voltage applied to the heater element 1 can be switched, for example, by electrically connecting the power source 200 to the first electrode 11 and the second electrode 12 of the heater element 1 by an electric wire 810 and operating a power switch 910 provided in the middle of the electric wire 810. The operation of the power switch 910 can be performed by the control unit 900.

The switching of turning-on and turning-off of the ventilation fan 600 can be done by, for example, electrically connecting the control unit 900 to the ventilation fan 600 via an electric wire 820 or wirelessly, and operating a switch (not shown) of the ventilation fan 600 using the control unit 900. The ventilation fan 600 can also be configured so that an airflow rate can be varied by the control unit 900.

The switching of the switching valve 300 can be performed, for example, by electrically connecting the control unit 900 to the switching valve 300 by the electric wire 830 or wirelessly, and operating a switch (not shown) of the switching valve 300 by the control unit 900.

The switching valve 300 is not particularly limited as long as it is a valve that is electrically driven and has the function of switching the flow path, and includes electromagnetic valves and electric valves. In an embodiment, the switching valve 300 includes an opening/closing door 312 supported by a rotating shaft 310 and an actuator 314 such as a motor that rotates the rotating shaft 310. The actuator 314 is configured to be controllable by the control unit 900.

From the viewpoint of stably ensuring the above functions, it is desirable that the heater element 1 of the vehicle interior purification system 1000 be placed at a position close to the vehicle interior. Therefore, from the viewpoint of preventing electric shock and the like, it is preferable that the driving voltage is 60V or less. Since the honeycomb structure 10 used in the heater element 1 has a low electrical resistance at room temperature, the honeycomb structure 10 can be heated at the low driving voltage. It should be noted that the lower limit of the driving voltage is not particularly limited, but it may preferably be 10 V or more. If the driving voltage is less than 10V, the current during heating the honeycomb structure 10 becomes large, so that the electric wire 810 should be thick.

In the embodiment illustrated in FIG. 15, the ventilation fan 600 is provided on an upstream side of the heater element 1. More specifically, the ventilation fan 600 is provided in the middle of the inflow pipe 400 that communicates the heater element 1 with the vehicle interior, so that the air passing through the ventilation fan 600 flows into the heater element 1 to be pushed into it. However, the ventilation fan 600 may be provided on a downstream side of the heater element 1. In this case, the ventilation fan 600 can be provided in the middle of the outflow pipe 500, for example, so that the air passing through the inflow pipe 400 flows into the heater element 1 to be sucked in.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### EXAMPLES

The invention will be more specifically described by means of the following Examples. The invention is not limited to these examples.

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.
Shape of cross section and end face of honeycomb structure orthogonal to flow path direction: circular or quadrangular;
Dimensions of the circular honeycomb structure: diameter of 120 mm, length of 10 mm;
Dimensions of the square honeycomb structure: horizontal width of 89 mm, vertical width of 68 mm, length of 10 mm;
Shape of cross section of cells orthogonal to flow path direction: quadrangular;
Thickness of partition walls: 0.127 mm;
Thickness of outer peripheral wall: 0.127 mm;
Cell density: 85.3 cells/cm²;
Cell pitch: 1.08 mm;
   Opening Ratio of Cells: 0.55 to 0.80;
Cross-sectional area of honeycomb structure orthogonal to extending direction of flow path: (circular) 11310 mm², (quadrangular) 6052 mm²;
Length of honeycomb structure in extending direction of flow path: 10 mm;
Volume resistivity of materials making up partition walls (and outer peripheral wall) at 25° C.: 12 Ω·cm; and
Curie point of material making up partition walls (and outer peripheral wall): 120° C.

The volume resistivity of the partition walls was controlled by adjusting the mixing ratio of the raw materials and firing conditions.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The first electrode and the second electrode each having a thickness of 0.05 mm were formed on both end faces (first end face and second end face) of the resulting honeycomb structure, respectively. The first electrode and the second electrode were formed as follows: First, an electrode slurry containing aluminum (electrode material), ethyl cellulose and diethylene glycol monobutyl ether (organic binder) was prepared and applied to the first end face. Subsequently, an excess electrode slurry on the outer periphery of the honeycomb structure was removed by blowing and wiping, and the electrode slurry was then dried to form an electrode on one end face. Similarly, an electrode was formed on the other end face.

Subsequently, the first metal terminal was joined onto the first electrode and the second metal terminal was joined onto the second electrode. The first metal terminal and the second metal terminal were joined as follows: Each of the first metal terminal and the second metal terminal used was a strip-shaped metal body made of SUS 430 and having a width of 3.5 mm and a thickness of 0.7 mm. The overall outer shape of the first metal terminal and the second metal terminal was a rectangular frame shape for the rectangular honeycomb structure, and a circular frame shape for the circular honeycomb structure. The first metal terminal and the second metal terminal were joined by soldering onto the first electrode and the second electrode, respectively, while aligning the outer edges of the first metal terminal and the second metal terminal with the outer edges of both end faces of the honeycomb structure, respectively.

As shown in the table below, the first metal terminal and the second metal terminal used were those integrated over the entire periphery of the honeycomb structure, and those divided into a plurality of partial electrodes as illustrated in FIGS. 1 to 15. When the first metal terminal and the second metal terminal were divided into a plurality of partial electrodes, the number of the first metal terminals and the second metal terminals divided were two or four.

When the first metal terminals and the second metal terminals each divided into a plurality of partial electrodes were used, the shapes of the end portions of the partial electrodes were changed. In the table, the “Z-shaped” refers to the shape of the end portion illustrated in FIGS. 5, 6 and 12, the “U-shaped” refers to the shape of the end portion illustrated in FIGS. 7 and 13, the “circular shaped” refers to the shape of the end portion illustrated in FIGS. 8 and 14, and the “No Fitting” refers to the shape illustrated in FIGS. 1 to 3 and 9 to 11.

The following evaluations were performed on each sample of the heater elements obtained as described above.

### <Thermal Stress>

A voltage of 13.5 V was applied to each sample for 3 minutes to confirm whether or not cracks appeared in the honeycomb structure. Samples that had no visible cracks were evaluated as acceptable, and those that had visible cracks were evaluated as failing.

### <Electrical Conduction Heating Characteristics>

A voltage of 13.5 V was applied to each sample for 3 minutes, and the temperature of each portion of each sample was measured.

In No. 1 in which the first metal terminal and the second metal terminal were integrally provided over the entire circumference of the honeycomb structure, a temperature (TC1) at the axial central position of the honeycomb structure was measured.

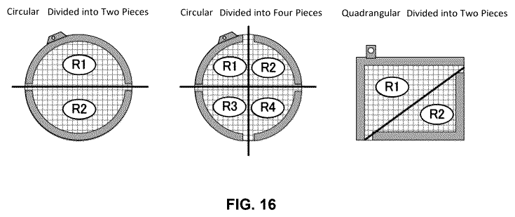

In Nos. 2 to 13, which used the first metal terminal and the second metal terminal divided into a plurality of partial electrodes, a situation where cracks occurred between the end portions of the partial electrodes was simulated, and temperatures (TC1 to TC4) at the central positions in regions R1 to R4 illustrated in FIG. 16 and a temperature (TC5) between the end portions of the partial electrodes were measured. The situation where cracks occurred was simulated as follows: After the honeycomb structure was divided into the same number as that of the first metal terminals and the second metal terminals divided, the first metal terminals and the second metal terminals were joined to the honeycomb structures. At this time, the first metal terminal and the second metal terminal were arranged so that the cut surface of the honeycomb structure was positioned between the end portions of the partial electrodes.

Samples in which the temperature at the axial central position or in each region R1 to R4 (TC1 to TC4) was 80° C. or higher and lower than 150° C. were evaluated as A, those in which it was 150° C. or higher and lower than 200° C. were evaluated as B, those in which it was 200° C. or higher were evaluated as C, and those in which it was lower than 80° C. were evaluated as D.

Also, those in which the maximum temperature difference (difference between the maximum temperature and the minimum temperature) of the temperature at the axial central position or in each region R1 to R4 (TC1 to TC4) was lower than 20° C. were evaluated as A, those in which it was 20° C. or higher and lower than 50° C. were evaluated as B, those in which it was 50° C. or higher and lower than 100° C. were evaluated as C, and those in which it was 100° C. or higher were evaluated as D.

Furthermore, those in which the temperature (TC5) between the end portions of the partial electrodes was lower than 150° C. were evaluated as A, and those in which the temperature (TC5) was 150° C. or higher were evaluated as B.

The results of the above evaluations are shown in the table below.

TABLE 1

| | | | | | | Current Conduction Heating Characteristics | | | | | |
|---|---|---|---|---|---|---|---|---|---|---|---|
| | Shape of | | Number of | | Thermal | | | | | Maximum | |
| | Honeycomb | Form of | Terminals | Fitting | Stress | | | | | Temperature | |
| Nos. | Structure | Metal Terminal | Divided | Shape | Cracks | TC1 | TC2 | TC3 | TC4 | Difference | TC5 |
| 1 | Circular | Integral | — | — | Failed | A | — | — | — | A | — |
| | | over Entire | | | | | | | | | |
| | | Circumference | | | | | | | | | |
| 2 | Circular | Divided | 2 | Z-shaped | Acceptable | A | A | — | — | A | A |
| 3 | Circular | Divided | 2 | U-shaped | Acceptable | A | A | — | — | A | B |
| 4 | Circular | Divided | 2 | Circular | Acceptable | A | A | — | — | A | B |
| 5 | Circular | Divided | 2 | No Fitting | Acceptable | A | D | — | — | D | A |
| 6 | Circular | Divided | 4 | Z-shaped | Acceptable | A | A | A | A | A | A |
| 7 | Circular | Divided | 4 | U-shaped | Acceptable | A | A | A | A | A | B |
| 8 | Circular | Divided | 4 | Circular | Acceptable | A | A | A | A | A | B |
| 9 | Circular | Divided | 4 | No Fitting | Acceptable | A | D | D | D | D | A |
| 10 | Quadrangular | Divided | 2 | Z-shaped | Acceptable | A | A | — | — | A | A |
| 11 | Quadrangular | Divided | 2 | U-shaped | Acceptable | A | A | — | — | A | B |
| 12 | Quadrangular | Divided | 2 | Circular | Acceptable | A | A | — | — | A | B |
| 13 | Quadrangular | Divided | 2 | No Fitting | Acceptable | A | D | — | — | D | A |

In the case of No. 1 in which the first metal terminal and the second metal terminal were integrally used over the entire circumference of the honeycomb structure, cracks were generated in the honeycomb structure. On the other hand, in Nos. 2 to 13 in which the first metal terminal and the second metal terminal were divided into a plurality of partial electrodes, no cracks were generated in the honeycomb structure. These results confirmed that by having a plurality of partial electrodes on the first metal terminal and the second metal terminal, the stress acting on the honeycomb structure due to the thermal expansion difference between the metal terminals and the honeycomb structure can be alleviated, and the risk of cracks occurring in the honeycomb structure could be reduced.

Among Nos. 2 to 13 in which the first metal terminal and the second metal terminal divided into a plurality of partial electrodes were used, the temperatures (TC1 to TC4) in the regions R1 to R4 of Nos. 2 to 4, 6 to 8, and 10 to 12, which adopted the fitting shape, were evaluated as A, but the temperatures (TC1 to TC4) in the regions R1 to R4 of Nos. 5, 9, and 13, which had “No Fitting”, were evaluated as D. This would be because, in the case of “No Fitting”, the divided parts of the honeycomb structure were electrically isolated and not heated, but by adopting the fitting shape, electrical isolation of the divided parts could be avoided. These results confirmed the advantages of adopting the fitting shape.

Further, in Nos. 2, 6, and 10 which had a “Z-shaped” fitting shape among Nos. 2 to 4, 6 to 8, and 10 to 12 which adopted the fitting shape, the temperature between the end portions of the partial electrodes (TC5) was evaluated as A, but the temperature between the end portions of the partial electrodes (TC5) was evaluated as B in Nos. 3, 4, 7, 8, 11, and 12 which adopted other fitting shapes. This would be because the “Z-shaped” allows the width of the first convex portion to be relatively large, thereby preventing the electrical resistance at the end portion from becoming high. These results confirmed the advantages of adopting the “Z-shaped”, i.e., the fitting shape in which at least a part of the end portion of the second partial electrode fits into the first concave portion of the first partial electrode in the circumferential direction of the honeycomb structure.

### DESCRIPTION OF REFERENCE NUMERALS

1: heater element
10: honeycomb structure
10a: first end face
10 b: second end face
11: first electrode
12: second electrode
13: first metal terminal
14: second metal terminal
15: partial electrode
100: outer peripheral wall
101: partition wall
101 a: cell
151: first partial electrode
151a: first convex portion
151b: first concave portion
152: second partial electrode
200: power source
300: switching valve
400: inflow pipe
500: outflow pipe
500a: first path
500 b: second path
600: ventilation fan
900: control unit
1000: vehicle interior purification system
EL1: extension line
EL2: extension line

1. A heater element comprising:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path, at least the partition walls being made of a material having a positive temperature coefficient (PTC) property;
a first electrode and a second electrode provided on the first end face and the second end face, respectively; and
a first metal terminal and a second metal terminal provided on the first electrode and the second electrode, respectively,
wherein at least one of the first metal terminal and the second metal terminal has a plurality of partial electrodes.

2. The heater element according to claim 1, wherein both the first metal terminal and the second metal terminal have a plurality of partial electrodes, respectively.

3. The heater element according to claim 1, wherein the plurality of partial electrodes are provided over the entire circumference of the honeycomb structure.

4. The heater element according to claim 1, wherein the plurality of partial electrodes comprise a first partial electrode and a second partial electrode adjacent to each other in a circumferential direction of the honeycomb structure, and end portions of the first partial electrode and the second partial electrode have fitting shapes that fit to each other.

5. The heater element according to claim 4, wherein the end portion of the first partial electrode comprises: a first convex portion provided in contact with an outer edge of the first partial electrode in a width direction of the honeycomb structure; and a first concave portion provided in contact with an extension line of an inner edge of the first partial electrode in the width direction of the honeycomb structure, the first concave portion being provided adjacent to the first convex portion in the width direction of the honeycomb structure, and
at least a part of the end portion of the second partial electrode enters the first concave portion in the circumferential direction of the honeycomb structure.

6. A vehicle interior purification system comprising:
at least one heater element according to claim 1;
a power source for applying a voltage to the heater element;
an inflow pipe that communicates a vehicle interior with the first end face of the heater element;
an outflow pipe having a first path that communicates the second end face of the heater element with the vehicle interior; and
a ventilation fan for allowing air from the vehicle interior to flow into the first end face of the heater element via the inflow pipe.

7. The vehicle interior purification system according to claim 6, wherein
the outflow pipe has, in addition to the first path, a second path that communicates the second end face of the heater element with a vehicle exterior,
the outflow pipe has a switching valve configured to switch the flow of the air passing through the outflow pipe between the first path and the second path, and
wherein the vehicle interior purification system comprises a control unit configured to perform switching between a first mode in which a voltage applied from the power source is turned off, the switching valve is switched so that the air flowing through the outflow pipe passes through the first path, and the ventilation fan is turned on; and a second mode in which the voltage applied from the power source is turned on, the switching valve is switched so that the air flowing through the outflow pipe passes through the second path, and the ventilation fan is turned on.
